(19) United States
(12) Patent Application Publication
(10) Pub. No.: US 2005/0226423 A1
(43) Pub. Date: Oct. 13, 2005

(54) Method for distributes the encrypted key in wireless lan

(76) Inventors: Yongmao Li, Shenzhen (CN); Gengshi Wu, Shenzhen (CN)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/506,765

(22) PCT Filed: Jan. 30, 2003
(86) PCT No.: PCT/CN03/00106

§ 371 Date: Apr. 14, 2005

(30) Foreign Application Priority Data
Mar. 8, 2002 (CN) 021109745

(51) Int. Cl. H04L 9/00

(52) U.S. Cl. 380/278

(57) ABSTRACT

A method for distributing encryption keys in WLAN that combines a key distribution process with an authentication process of mobile hosts and utilizes an authentication server or a wireless gateway to manage key distribution so that mobile hosts can roam in a scope larger than the coverage area of the key management server. Because the key distribution does not transmit the key, which is not encrypted via the air interface, the method ensures the key is safe. In addition, the method can be used under different WLAN protocols. Because the AP does not need to manage user information, the method simplifies AP structure, and thus lowers the cost.

### BACKGROUND OF THE INVENTION

1. Field of the Invention

The present invention relates to communication between APs (Access Point) in WLAN (Wireless Local Area Network) and any mobile host, particularly to a method for distributing encryption keys.

2. Description of the Related Art

WLAN transfers data, voice, and video signals through wireless channels. Compared with traditional networks, WLAN is easy to install, flexible to use, economical, and easy to extend, etc., and is favored by more and more users.

The coverage area of WLAN is called as service area, which is usually divided into Basic Service Area (hereinafter referred as BSA) and Extended Service Area (hereinafter referred as ESA); wherein BSA refers to the communication coverage area determined by transceivers of individual units in the WLAN and the geographic environment and is usually called as cell, the scope of which is generally small; the method shown in FIG. 1 is usually used to extend the coverage area of WLAN, i.e., the BSA is connected to the backbone network (usually a wired LAN) via the APs and the wireless gateway, so that mobile hosts (MHs) in the BSA are connected to the backbone network via the APs and the wireless gateway to constitute a ESA.

Compared with wire transmission, the confidentiality of wireless transmission is lower; therefore, to ensure communication security between the APs of the cell and the mobile hosts, information should be encrypted with keys before transmitted. When a mobile host moves across cells or powers on, it searches for the local cell, registers itself to the AP of the cell, and obtains information related with the cell; therefore, the encryption communication between the mobile host and the APs will be restricted to some extent. In detail, for example, when the mobile host MH12 moves from cell 1 into cell 2, if AP11 and AP12 is in the coverage area of the same key management server, then the encryption communication between mobile host MH12 and AP11 can be smoothly transited to between MH12 and AP21; however, if AP11 and AP21 are managed by different key management servers, then encryption communication between MH12 and AP21 can not be realized directly in cell 2 because AP21 can not obtain the communication key of MH12. However, if the mobile host MH12 sends its key to AP21 through the wireless channel without encryption, the system will be vulnerable because the key may be intercepted and deciphered easily.

As described above, it is obvious that the method for distributing encryption keys in the prior art will result in restrictions to encryption communication when the mobile host roams across cells.

### BRIEF SUMMARY OF THE INVENTION

The present invention provides a new method for distributing encryption keys in WLAN.

In a method for distributing encryption keys in WLAN according to the present invention, said WLAN comprises an AP and a plurality of mobile hosts storing identification information, said mobile hosts communicate with said AP through wireless channels, said AP and the external network connect with the authentication device which authenticates said mobile hosts; said authentication device stores identification information of all mobile hosts, said method comprises the following steps:

(1) a mobile host sending an authentication request containing identification information to the authentication device for identity authentication;

(2) the authentication device authenticating the mobile host according to identification information contained in the authentication request, if the authentication fails, the authentication device sending an ACCEPT_REJECT message to the mobile host via the AP; if the authentication succeeds, the authentication device sending key-related information M1 to AP and sending an message comprising ACCESS_ACCEPT information to the mobile host via the AP; if containing key-related information M2, said message being encrypted;

(3) AP obtaining the key from the key-related information M1 sent from the authentication device, and the mobile host obtaining the key from said message sent from the authentication device via the AP.

As shown above, the method of the present invention combines key distribution process with authentication process of the mobile hosts and utilizes an authentication device to manage key distribution, so that mobile hosts can roam in a scope larger than the coverage area of the key management server. Because the key distribution does not involve transmitting the key which is not encrypted via the air interface, the method ensures the key is safe. In addition, said method does not depend on specific authentication modes, so it can be used under different kinds of WLAN protocols. Finally, because AP does not need to manage user information, the method simplifies AP structure, and thus lowers the cost.

### BRIEF DESCRIPTION OF THE DRAWINGS

Various advantages, characteristics, and features of the present invention can be understood better through description of the embodiments hereunder with reference to the attached drawings, wherein:

FIG. 1 is a schematic diagram of connection between a WLAN and a wired backbone network via the AP and a wireless gateway;

FIG. 2a is a schematic diagram of the encryption communication method in WLAN according to an embodiment of the present invention;

FIG. 2b is a schematic diagram of the encryption communication method in WLAN according to another embodiment of the present invention;

FIG. 2c is a schematic diagram of the encryption communication method in WLAN according to another embodiment of the present invention;

FIG. 2d is a schematic diagram of the encryption communication method in WLAN according to another embodiment of the present invention;

FIG. 3a shows an example of the dynamic negotiation process for the keys in WLAN;

FIG. 3b shows another example of the dynamic negotiation process for the keys in WLAN;

FIG. 3c shows another example of the dynamic negotiation process for the keys in WLAN; and

FIG. 3d shows another example of the dynamic negotiation process for the keys in WLAN.

### DETAILED DESCRIPTION OF THE EMBODIMENTS

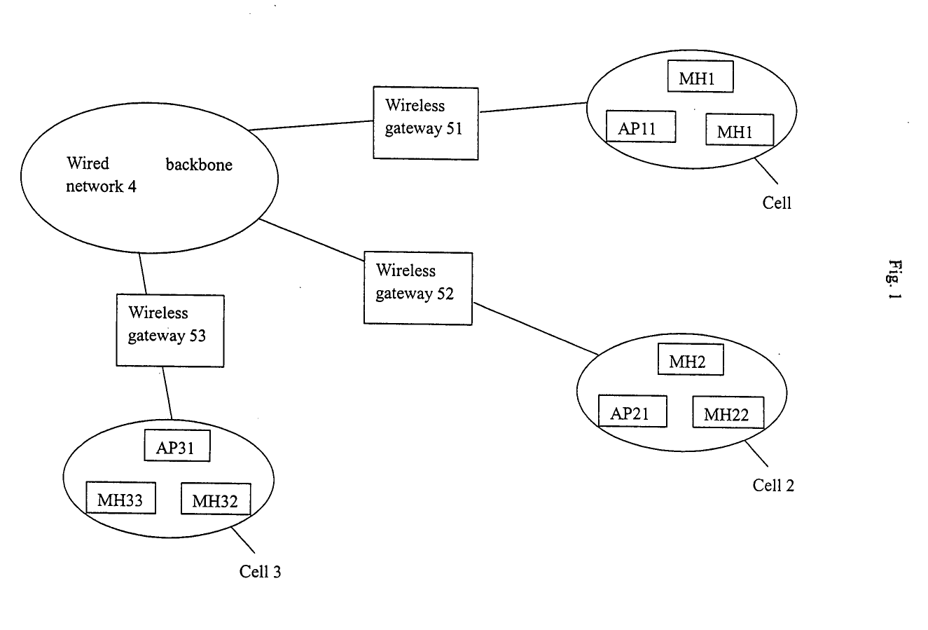

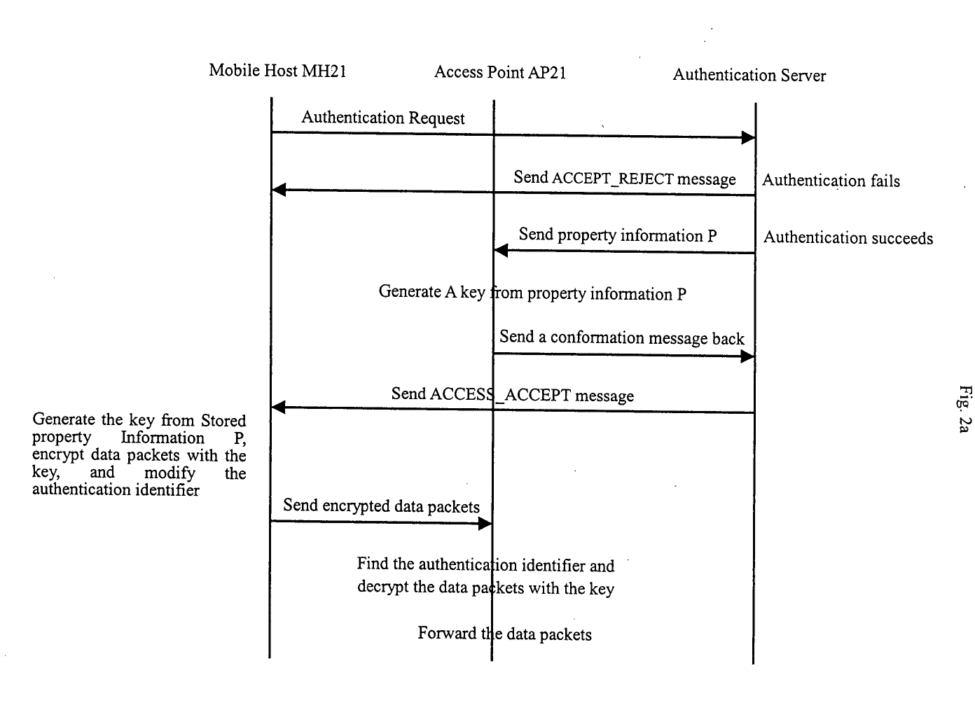

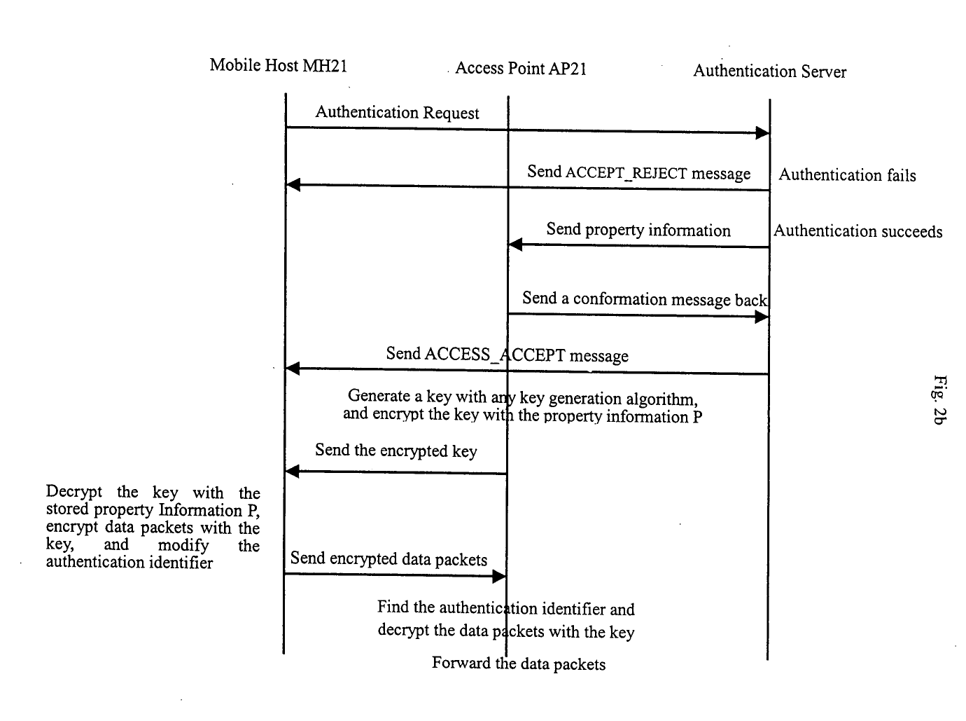

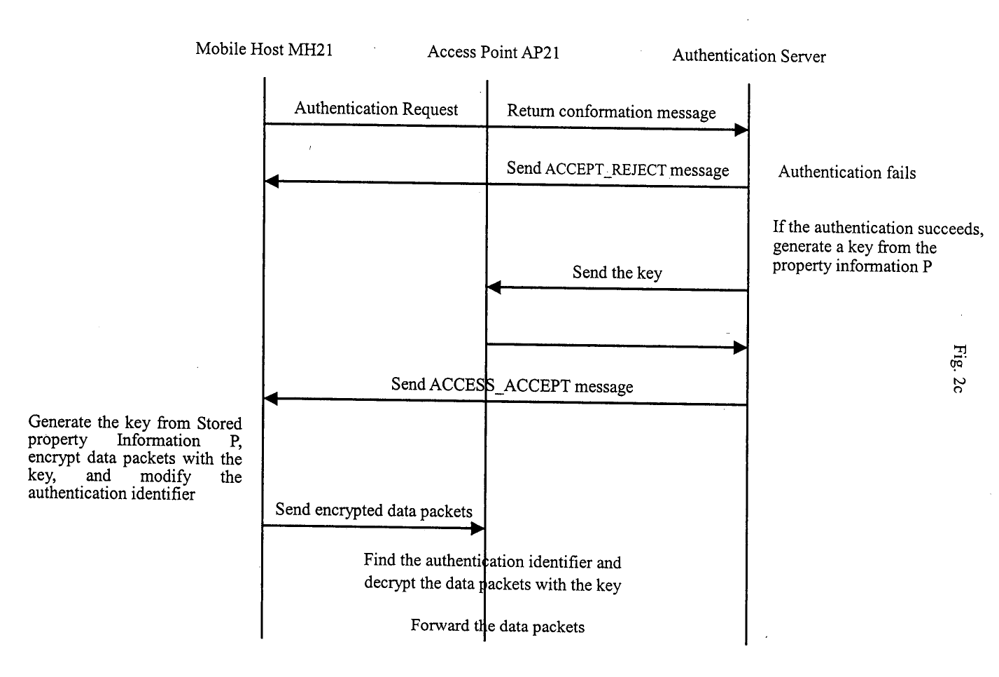

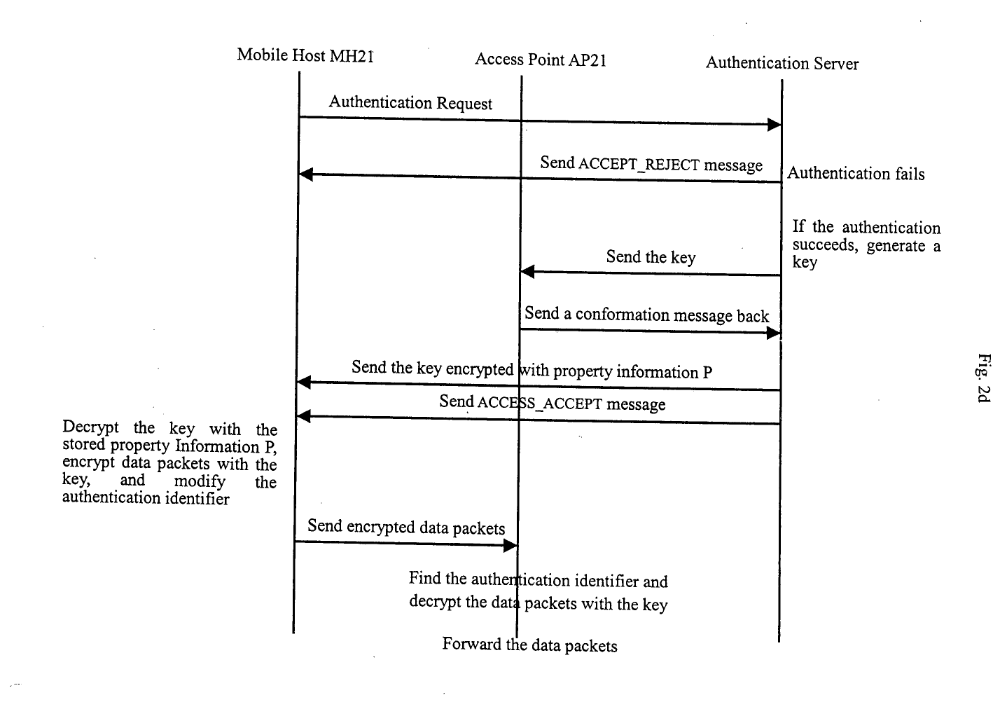

Hereunder the method for distributing encryption keys in WLAN according to the embodiments of the present invention is described in detail with reference to FIG. 1 and FIG. 2a to 2d.

As shown in FIG. 1, cell 1 to 3 include AP11, AP21 and AP31, and several mobile hosts MH12 to MH33 respectively, each of the mobile hosts stores identity information I and property information P and communicates with the AP in the corresponding cell through a wireless channel; the APs are connected to a wired backbone network 4 via wireless gateways 51 to 53; the authentication server (not shown) in the backbone network contains identity information I and property information P of all mobile hosts in all cells, and it can also obtain user lists storing identity information I and property information P of mobile hosts from external devices; therefore the authentication server can authenticate any mobile host according to the identity information I or the identity information I stored in the user lists. It should be noted that the identity information I and the property information P of mobile hosts can also be managed by wireless gateways 51 to 53, therefore the mobile hosts can be authenticated by the wireless gateways. In addition, the mobile hosts can also be authenticated by the authentication server and the wireless gateways interoperably. For those skilled in the art, authentication of mobile hosts is the prior art and can be implemented in various ways, and said methods are only a part of them; for convenience, any device which can authenticate the mobile hosts will be considered as an authentication device.

FIG. 2a shows the initial key distribution and the encryption communication between mobile host MH12 and AP21 when MH12 moves into cell 2 from cell 1.

The mobile host MH12 establishes a connection with AP21 and sends an authentication request containing identity information to the authentication server in the backbone network 4 for authentication via AP21 and the wireless gateway 51. When receiving the authentication request, the authentication server authenticates the mobile host according to the identity information I contained in the authentication request; if the identity information I is inconsistent with the stored one, the authentication server deems the mobile host as an illegal one and rejects the authentication request, and then sends an ACCEPT_REJECT message to MH11 via the wireless gateway 51 and AP21; if the identity information I contained in the authentication request is consistent with the stored one, the authentication server deems the mobile host as a legal one and accepts the authentication request, and then, as shown in FIG. 2a, the authentication server searches for the corresponding property information P of the mobile host MH12 according to the identity information I and then sends it to AP21 via the wireless gateway 51. When receiving the property information P sent from the authentication server, AP21 sends a confirmation message back to the authentication server via the wireless gateway for safe receipt of the property information P and generates a key from the property information P with the key generation algorithm. The key generation algorithm can be any kind of algorithm, and the length of the key is free. When receiving the confirmation message from AP21, the authentication server sends an ACCESS_ACCEPT message to MH21 via the wireless gateway 51 and AP21. When receiving the ACCESS_ACCEPT message, the mobile host MH21 generates a key from the property information P stored in itself with the same key generation algorithm as the one with which AP21 generates a key, and then encrypts data packets to be sent to AP21 with the key, and sends the encrypted data packets to AP21; MH21 adds an encryption identifier in the data packets when encrypting the data packets. When receiving the data packets from MH21, AP21 detects the encryption identifier in the data packets; if the encryption identifier is found, AP21 decrypts the data packets with the key obtained from property information P and the key generation algorithm, and then forwards the decrypted data packets to the external network 4 via the wireless gateway 51; otherwise AP21 directly forwards the original data packets to the external network 4 via the wireless gateway 51.

FIG. 2b is a schematic diagram of the encryption communication method in WLAN according to another embodiment of the present invention. The difference between this embodiment and that of FIG. 2a is: in the communication process, the key is generated with any key generation algorithm and then encrypted with property information P by AP21, and then sent to MH21. When receiving the key from AP21, MH21 decrypts the key with the property information P stored in itself, encrypts the data packets to be sent to AP with the decrypted key and sends them to AP. MH21 also adds an encryption identifier in the data packets when encrypting the data packets. In this case, each of the mobile hosts does not need to know the key generation algorithm used by AP21.

FIG. 2c is a schematic diagram of the encryption communication method in WLAN according to another embodiment of the present invention. The difference between this embodiment and that of FIG. 2a is: when the authentication succeeds, the authentication server generates the key from the found property information P with the key generation algorithm and then sends the key to AP21 instead of sending the property information P to AP21 to generate the key.

FIG. 2d is a schematic diagram of the encryption communication method in WLAN according to another embodiment of the present invention. The difference between this embodiment and that of FIG. 2c is: when the authentication succeeds, the authentication server generates the key with the key generation algorithm and then sends the key to AP21, and at the same time, the authentication server also sends the key encrypted with the property information P to MH21.

It should be noted that the backbone network 4 may includes a plurality of authentication servers, which connect with each other under certain communication protocols to exchange identification information of the mobile hosts stored in them; so that the service area can be extended further.

In above embodiments, if the mobile hosts are authenticated by the wireless gateway 51 to 53 independently, other functions of authentication server can also be implemented on the wireless gateways, for example, wireless gateways 51 to 53 can be configured to send ACCESS_ACCEPT message to MH21, generate the key, and send property information P to AP21, etc. Similarly, if the confirmation function is implemented by the authentication server and the wireless gateways interoperably, other functions of the authentication server can also be implemented by the authentication server and the wireless gateways interoperably. In general, all functions of the authentication server can be implemented by the authentication device.

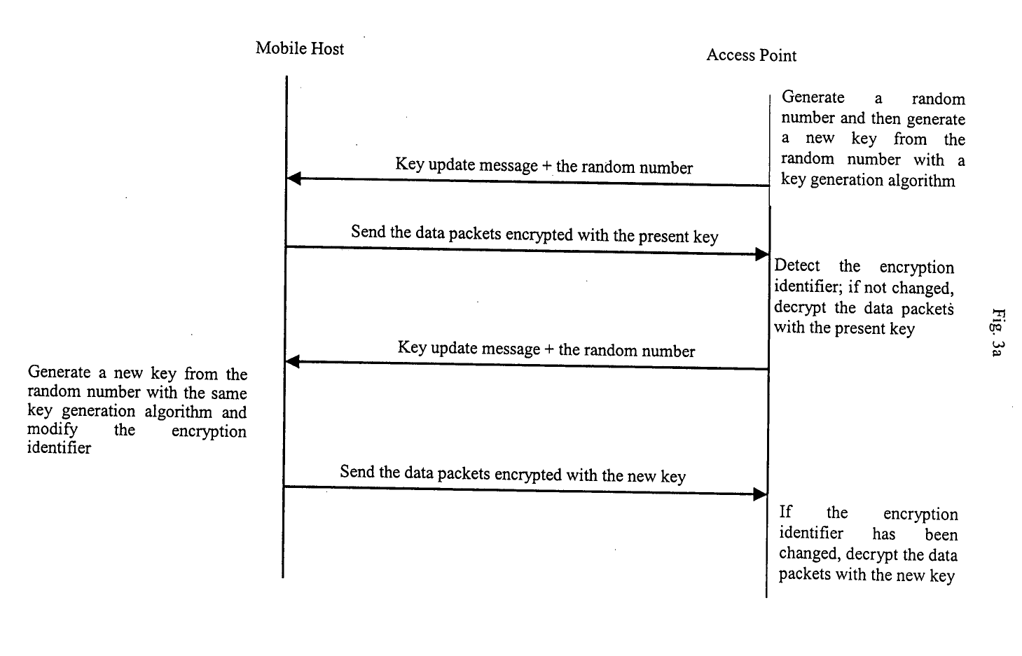

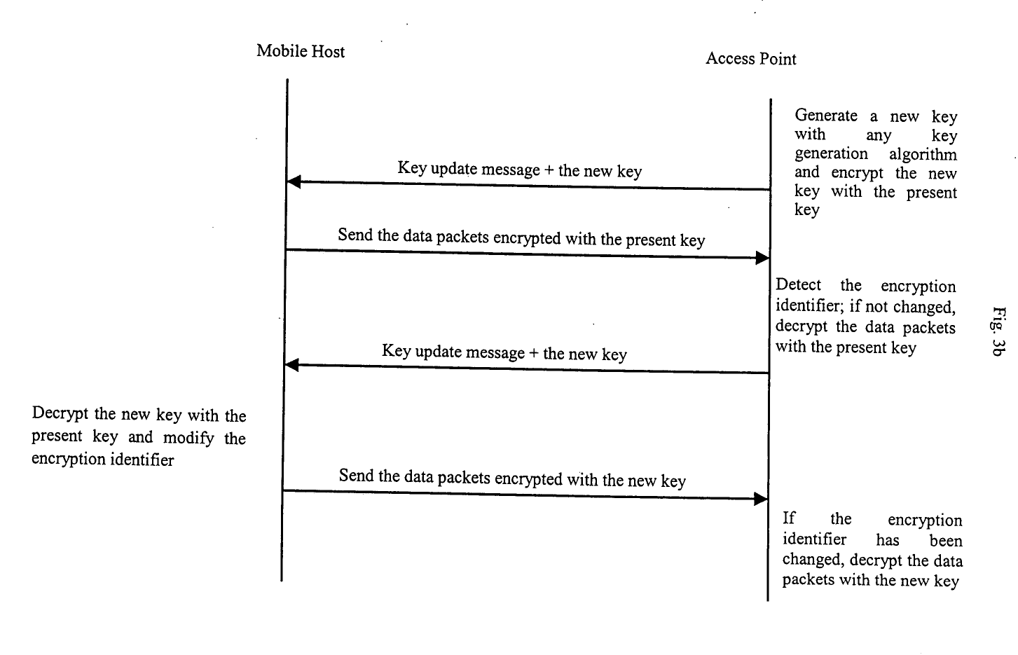

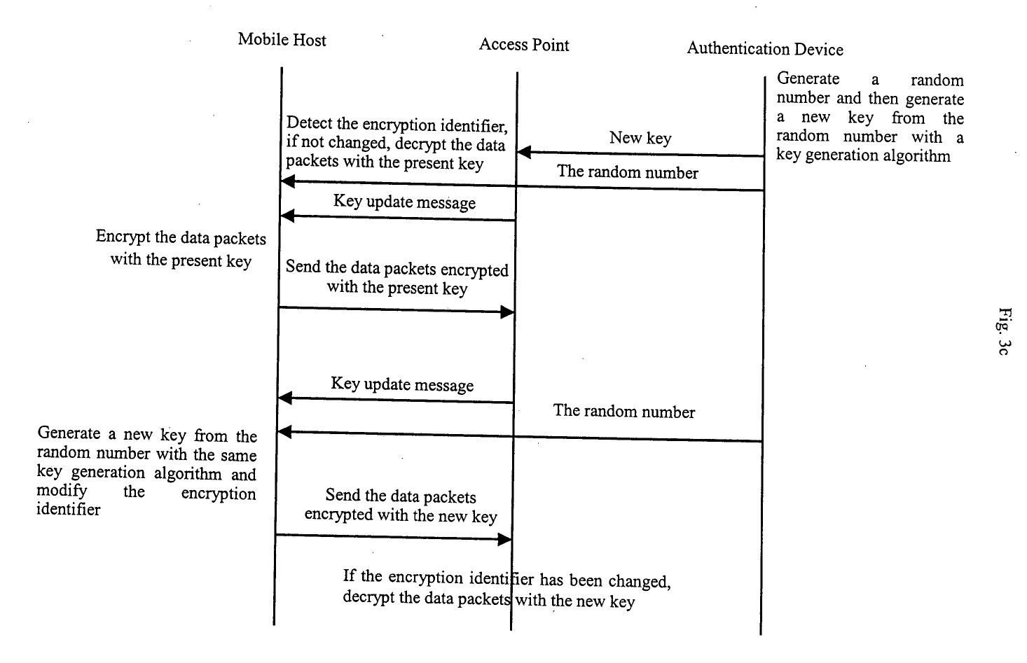

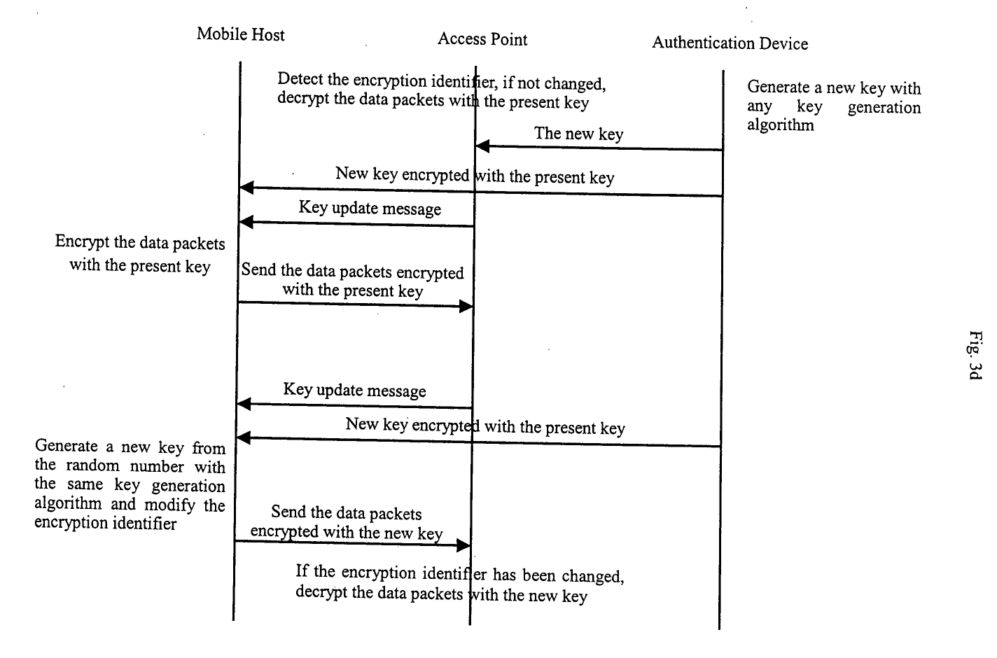

In above encryption communication in the WLAN, to enhance system security further, the communication key between AP and the mobile host can also be updated periodically or aperiodically. Hereunder several examples of such dynamic negotiation for keys are described with reference to FIG. 3a to 3d.

As shown in FIG. 3a, in order to update the key, AP generates a random number first and generates a key from the random number with any key generation algorithm; then AP adds the random number in the key update message and then sends the message to the mobile host. When receiving the key update message, the mobile host generates the key from the random number contained in the key update message with the same key generation algorithm, encrypts the data packets to be sent to AP with the key, and then sends the data packets to AP; when encrypting the data packets, the mobile host still adds the encryption identifier in the data packets and changes the value of the encryption identifier to indicate the communication key has been changed.

FIG. 3b shows another example of dynamic negotiation for the keys. As shown in FIG. 3b, in order to update the key, AP generates a new key in a random way, encrypts the newly generated key with the present key, and adds the encrypted key to the key update message, and then sends the message to the mobile host. When receiving the key update message, the mobile host decrypts the new key contained in the key update message with the present key, encrypts the data packets to be sent to AP with the new key, and then sends the encrypted data packets to AP; when encrypting the data packets, the mobile host also adds the encryption identifier to the data packets and change the value of the encryption identifier to indicate the communication key has been changed.

FIG. 3c shows another sample of the dynamic negotiation for the keys. As shown in FIG. 3c, in order to update the key, the authentication device generates a random number, generates a key from the random number with any key generation algorithm, and sends the random number to the mobile host and sends the generated key to AP. When receiving the key from the authentication device, AP sends a key update message to the mobile host. When receiving the key update message and the random number, the mobile host generates the key with the same key generation algorithm, encrypts the data packets to be sent to AP with the key, and then sends the encrypted data packets to AP; when encrypting the data packets, the mobile host also adds the encryption identifier to the data packets and change the value of the encryption identifier to indicate the communication key has been changed.

FIG. 3d shows another sample of dynamic negotiation for the keys. As shown in FIG. 3d, in order to update the key, the authentication device generates a new key in a random way, sends the key to AP, then encrypts the new key with the present key, and sends the encrypted key to the mobile host. When receiving the unencrypted key from the authentication device, AP sends a key update message to the mobile host. When receiving the key update message and the encrypted key, the mobile host decrypts the encrypted key with the present key to obtain a new key, encrypts the data packets to be sent to AP with the new key, and then sends the encrypted data packets to AP; when encrypting the data packets, the mobile host also adds the encryption identifier in the data packets and change the value of the encryption identifier to indicate the communication key has been changed.

In above dynamic negotiation process, if AP finds the value of encryption identifier in the data packets sent from the mobile host is not changed after the key update message is sent, it will resend the key update message and the random number or encrypted new key, till the mobile host communicates with the new key.

As shown above, the key distributing method does not involve logon management, authentication management, and mobile management in WLAN; therefore it can be implemented under all different kinds of WLAN protocols, including PPPoE, IEEE 802.1x, etc. To better understanding the advantages, characteristics and object of the present invention, the key distributing method in the embodiment of the present invention will now be described with reference to IEEE 802.1x.

IEEE 802.1x is a commonly-used WLAN protocol, involving standards of MAC layer and physical layer, wherein the unit of data packets between AP and mobile hosts is MAC frame. IEEE 802.1x messages mainly include: EAP_START, EAP_LOGOOF, EAP_REQUEST, EAP_RESPONSE, EAP_SUCCESS, EAP_FAIL and EAP_KEY, which are special MAC frames because they are identified by the Type field in MAC frame.

After establishing a connection with AP, the mobile host sends an EAP_START message to AP; when receiving the message, AP sends an EAP_REQUEST/IDENTITY message to the mobile host to request the user to input user name and password. After the user inputs the user name and password, the mobile host encapsulates them in the EAP_RESPONSE/IDENTITY message and sends the message back to AP. AP encapsulates user name and password provided by the user into an ACCESS_REQUEST message and then sends the message to the authentication server; the communication between AP and the authentication server complies with Radius protocol. The authentication server checks whether the user name and password match first; if not, the authentication server determines the authentication failed and sends an ACCEPT_REJECT message to AP. When receiving the message, AP sends an EAP_FAIL message to the mobile host to reject access of the mobile host. If the authentication succeeds, the authentication server will send an ACCESS_ACCEPT message to AP and add property information P corresponding to the user in the data field of the message. When AP receives the message, as described in above key distributing method, the key can be generated from the property information P with a key generation. algorithm and an EAP_SUCCESS message is sent to the mobile host, or the key can be encrypted with the property information P and then sent to the mobile host in an EAP_KEY message. Accordingly, the mobile host can generate the key from the stored property information P with the same key generation algorithm or decrypts the received key with the corresponding property information P. Next, the mobile host encrypts MAC frame data with the key and then sends the encrypted MAC frame data to AP; at the same time, it adds the encryption identifier in the MAC frames. Field of the frame body comprises IV field, data field and ICV field; especially, the IV field contains a 2-bit KeyID field, which serves as the synchronization flag. Preferably, when the MAC frames are not encrypted, KeyID=0; after the encryption communication starts, KeyID is increased by 1 whenever the key is updated, i.e., KeyID=KeyID+1; when KeyID=3, it will be reset to 1 instead of 0 during the next key update operation. Therefore, when the MAC data is encrypted at the first time, the field KeyID=1 in the MAC frames sent by the mobile host; when receiving the MAC frames with KeyID=1, AP determines the mobile host has used a new key and then decrypts MAC data with said generated key, converts the MAC data into Ethernet format to forwards to the wired network. If detecting the KeyID in MAC frames uploaded by the mobile host is still 0 after sending the EAP_KEY message, AP will resend the EAP_SUCCESS or EAP_KEY message.

In order to update the communication key dynamically, after the mobile host logs on, AP may send the EAP_KEY message periodically (e.g., once every 10 minutes) or aperiodically to inform the mobile host to update the key. In the latest EAP_KEY message, the random number used to generate the new key or the new key encrypted with the present key may be included selectively. When receiving the message, the mobile host can generate the new key from the random number with the same key generation algorithm or decrypts the new key with the present key. Next, the mobile host encrypts MAC data with the new key and set KeyID=2 at the same time. AP detects the KeyID field in MAC frames uploaded; if the KeyID is not changed, it continues using the present key to decrypt the MAC data and resends the EAP_KEY message at the same time; if the KeyID has been changed, it will use the new key to decrypt the MAC data.

1. A method for distributing encryption keys in WLAN, said WLAN having an AP and a plurality of mobile hosts storing identification information, the mobile hosts communicating with the AP through wireless channels, the AP and the external network connecting with the authentication device which authenticates the mobile hosts, the authentication device storing identification information of all mobile hosts, the method comprising the following steps:
(1) a mobile host sending an authentication request containing identification information to the authentication device for identity authentication;
(2) the authentication device authenticating the mobile host according to identification information contained in the authentication request, and if the authentication fails, the authentication device sending an ACCEPT_REJECT message to the mobile host via the AP, and if the authentication succeeds, the authentication device sending key-related information M1 to AP and sending a message comprising ACCESS_ACCEPT information to the mobile host via the AP, and if containing key-related information M2, said message being encrypted; and
(3) AP obtaining the key from the key-related information M1 sent from the authentication device, and the mobile host obtaining the key from said message sent from the authentication device via the AP.

2. The method for distributing encryption keys in WLAN of claim 1 wherein said information M1 is the corresponding property information searched by said authentication device according to the identification information contained in the authentication request, said AP obtains the key through generating it from said property information with a key generation algorithm; whereas said mobile host obtains the key through generating it from property information stored in itself with the same key generation algorithm after said mobile host receives said message comprising ACCESS_ACCEPT information forwarded by AP.

3. The method for distributing encryption keys in WLAN of claim 1 wherein said information M1 is the corresponding property information searched by said authentication device according to the identification information contained in the authentication request, said AP obtains the key through generating it with a key generation algorithm; said information M2 is the key generated and encrypted by AP with said property information and then sent to said mobile host along with said ACCESS_ACCEPT message, said mobile host obtains the key through decrypting information M2 with said property information.

4. The method for distributing encryption keys in WLAN of claim 1 wherein said information M1 is the key generated from said property information corresponding to the identification information contained in said authentication request by said authentication device with a key generation algorithm, said mobile host obtains the key through generating it from said property information stored in itself with the same key generation algorithm after receiving said ACCESS_ACCEPT message.

5. The method for distributing encryption keys in WLAN of claim 1 wherein said information M1 and M2 are the key generated from said property information corresponding to the identification information contained in said authentication request by said authentication device with a key generation algorithm, said information M2 is encrypted with said property information and then sent to said mobile host along with said ACCESS_ACCEPT message, said mobile host obtains the key through decrypting said information M2 with the property information stored in itself after receiving said ACCESS_ACCEPT message.

6. The method for distributing encryption keys in WLAN of claim 1 wherein when receiving data packets encrypted with a key sent from the mobile host, said AP updates the key through the following steps of:
(a1) said AP generating a random number and generating a new key from said random number with any key generation algorithm;
(b1) said AP adding said random number to a key update message and then sending said message to said mobile host;
(c1) when receiving said key update message, said mobile host generating a new key from said random number contained in said key update message with the same key generation algorithm as that in step (a1);
(d1) said mobile host encrypting the data packets to be sent to AP with said new key and then sending the encrypted data packets to AP, during the encryption process, said mobile host adding an encryption identifier to said data packets and changing the value of said encryption identifier to indicate the communication key has been changed; and
(e1) when receiving the data packets from said mobile host, said AP determines whether to change the key according to value of said encryption identifier.

7. The method for distributing encryption keys in WLAN of claim 1 wherein in order to achieve encryption communication with the new key, when receiving the data packets encrypted with the key sent from said mobile host, said AP updates the key periodically or aperiodically through the following steps of:
(a2) said AP generating a new key in any way and encrypting said new key with the present key;
(b2) said AP adding the encrypted key to the key update message and then sending said message to said mobile host;
(c2) when receiving said key update message, said mobile host decrypting the new key contained in said key update message with the present key so as to obtain said new key;
(d2) said mobile host encrypting the data packets to be sent to AP with said new key and then sending the encrypted data packets to AP, during the encryption process, said mobile host adding an encryption identifier to said data packets and changing the value of said encryption identifier to indicate the communication key has been changed; and
(e2) when receiving the data packets from said mobile host, said AP determines whether to change the key according to value of said encryption identifier.

8. The method for distributing encryption keys in WLAN of claim 1 wherein when receiving the data packets encrypted with the key sent from said mobile host, said AP updates the key periodically or aperiodically through the following steps of:
(a3) said Authentication device generating a random number which is used to generate a new key with the key generation algorithm, and then said authentication device sending said new key to AP, and sending said random number to said mobile host via AP;
(b3) said AP sending said key update message to said mobile host after receiving said new key;
(c3) when receiving said random number from said authentication device and said key update message from AP, said mobile host generating a new key from said random number with the same key generation algorithm as that in step (a3);
(d3) said mobile host encrypting the data packets to be sent to AP with said new key and then sending the encrypted data packets to AP, during the encryption process, said mobile host adding an encryption identifier to said data packets and changing the value of said encryption identifier to indicate the communication key has been changed; and
(e3) when receiving the data packets from said mobile host, said AP determines whether to change the key according to value of said encryption identifier.

9. The method for distributing encryption keys in WLAN of claim 1 wherein in order to achieve encryption communication with the new key, when receiving the data packets encrypted with the key sent from said mobile host, said AP updates the key periodically or aperiodically through the following steps of:
(a4) said AP generating a new key in any way and encrypting said new key with the present key, then sending said new key to said AP, whereas sending the encrypted new key to said mobile host via said AP;
(b4) after receiving said new key, said AP sending a key update message to said mobile host;
(c4) when receiving the encrypted key from said authentication device and said key update message from said AP, said mobile host decrypting the encrypted key with the present key to obtain a new key;
(d4) said mobile host encrypting the data packets to be sent to AP with said new key and then sending the encrypted data packets to AP, during the encryption process, said mobile host adding an encryption identifier to said data packets and changing the value of said encryption identifier to indicate the communication key has been changed; and
(e4) when receiving the data packets from said mobile host, said AP determines whether to change the key according to value of said encryption identifier.

10. The method for distributing encryption keys in WLAN of claim 1 wherein said authentication device is an authentication server installed in said external network.

11. The method for distributing encryption keys in WLAN of claim 6 wherein said authentication device is an authentication server installed in said external network.

12. The method for distributing encryption keys in WLAN of claim 7 wherein said authentication device is an authentication server installed in said external network.

13. The method for distributing encryption keys in WLAN of claim 8 wherein said authentication device is an authentication server installed in said external network.

14. The method for distributing encryption keys in WLAN of claim 9 wherein said authentication device is an authentication server installed in said external network.

15. The method for distributing encryption keys in WLAN of claim 1 wherein said authentication device is a wireless gateway that connects said AP with said external network.

16. The method for distributing encryption keys in WLAN of claim 6 wherein said authentication device is a wireless gateway that connects said AP with said external network.

17. The method for distributing encryption keys in WLAN of claim 7 wherein said authentication device is a wireless gateway that connects said AP with said external network.

18. The method for distributing encryption keys in WLAN of claim 8 wherein said authentication device is a wireless gateway that connects said AP with said external network.

19. The method for distributing encryption keys in WLAN of claim 9 wherein said authentication device is a wireless gateway that connects said AP with said external network.

20. The method for distributing encryption keys in WLAN of claim 1 wherein said authentication device includes said wireless gateway and said authentication server installed in external network.

21. The method for distributing encryption keys in WLAN of claim 6 wherein said authentication device includes said wireless gateway and said authentication server installed in external network.

22. The method for distributing encryption keys in WLAN of claim 7 wherein said authentication device includes said wireless gateway and said authentication server installed in external network.

23. The method for distributing encryption keys in WLAN of claim 8 wherein said authentication device includes said wireless gateway and said authentication server installed in external network.

24. The method for distributing encryption keys in WLAN of claim 9 wherein said authentication device includes said wireless gateway and said authentication server installed in external network.
